(19) United States
(12) Patent Application Publication
(10) Pub. No.: US 2026/0249964 A1
(43) Pub. Date: Aug. 27, 2026

(54) COUNTERWEIGHT FOR SEMI-SUBMERSIBLE FLOAT OF OFFSHORE WIND TURBINE AND INSTALLATION METHOD THEREFOR

(71) Applicant: SAIPEM S.A., Puteaux (FR)

(72) Inventor: Mohamed SOUALMI, Puteaux (FR)

(21) Appl. No.: 19/163,465

(22) PCT Filed: Mar. 4, 2024
(86) PCT No.: PCT/FR2024/050263

§ 371 Date: Sep. 9, 2025

(30) Foreign Application Priority Data
Mar. 9, 2023 (FR) FR2302211

(51) Int. Cl. B63B 43/06; B63B 35/44; B63B 75/00

(52) U.S. Cl. CPC B63B 43/06; B63B 35/44; B63B 75/00; B63B 2035/446

(57) ABSTRACT

A counterweight for a semi-submersible float of an offshore wind turbine can be configured in a sinking state or a floating state, and includes a main counterweight structure made of a material that makes it sinking when immersed in water, and a plurality of airbags removably fixed to the main structure so as to make the counterweight floating when the airbags are inflated. A method is provided for installing such a counterweight

### TECHNICAL FIELD

The present invention relates to the general field of semi-submersible floats for offshore wind turbines equipped with a pendulum counterweight. It more specifically concerns the counterweight used to ensure the stability of such a float.

### PRIOR ART

An offshore wind turbine aims to use the energy of the wind in order to produce electricity using a turbine and an electric generator. There are two main types of offshore wind turbines: fixed wind turbines which are implanted on the seabed (at shallow depths, typically less than 50 m), and floating wind turbines which offer the advantage of being able to be built onshore and implanted in areas where the depth of the seabed typically exceeds 50 m.

The floating wind turbines covered by the present invention comprise a turbine generally formed by a motor with several horizontal-axis rotating airfoils and an electric generator coupled to the motor, the motor and the generator being fixed to an upper end of a vertical mast (or pylon). The lower end of the mast is mounted on a floating support structure.

There are several main families of floating support structures for offshore wind turbines: semi-submersible floats, immersed floats with tensioned cables (or TLP platforms for Tension-Leg Platform), floats of the SPAR (Single Point Anchor Reservoir) type, semi-submersible floats of the barge type, and semi-submersible floats with a pendulum counterweight.

Semi-submersible floats constitute currently the most widespread float model. It is a steel or concrete foundation that generally takes the form of a tripod with three (or four) cylindrical columns connected together by metal structures. The stability of the structure is ensured by a counterweight that allows part of the foundation to be immersed. This structure is characterized by its large size and reduced draft.

Reference may be made to publication WO 2019/106283 which describes a semi-submersible float structure and a method for installing a wind turbine equipped with such a float structure. In this publication, the counterweight consists of a basket able to receive ballast material. In practice, this basket is transported empty to the area of implantation of the wind turbine, then is gradually filled with the ballast material in order to tension the ballast links which connect it to the floating support structure.

### DISCLOSURE OF THE INVENTION

The object of the invention is to propose an alternative counterweight structure for a semi-submersible float of an offshore wind turbine.

In accordance with the invention, this object is achieved by means of a counterweight for a semi-submersible float of an offshore wind turbine, which can be configured in a sinking state or a floating state, comprising a main counterweight structure made of a material that makes it sinking when immersed in water, and a plurality of airbags removably fixed to the main structure so as to make the counterweight floating when the airbags are inflated.

The counterweight according to the invention is remarkable in that it is made of a material that makes it sinking but can be configured in a floating state using airbags. Particularly, because it can be configured in a floating state, its towing to the offshore wind turbine installation site is greatly facilitated. Particularly, it is not necessary to use an offshore crane for its installation.

The main structure may be made of concrete, steel or composite materials.

The main structure may have a cylindrical or polyhedral shape with a plurality of lateral faces on which the airbags are removably fixed. In this case, the main structure may have the shape of a hexagonal prism.

The invention also relates to a method for installing a counterweight as defined above, comprising, in an indeterminate order:
securing at the dock the deflated airbags to the main structure;
inflating the airbags to make the counterweight floating prior to launching it into the water;
launching into the water the counterweight in its floating state;
towing the counterweight to the offshore wind turbine installation site;
connecting, via tendons, the counterweight under the semi-submersible float of the offshore wind turbine; and
lowering the counterweight under the semi-submersible float in order to tension the tendons and exert a downward force on the semi-submersible float.

The method may comprise towing the counterweight in its floating state to the offshore wind turbine installation site separately from towing the semi-submersible float of the offshore wind turbine, followed by connecting the tendons pre-installed on the float to the counterweight.

Alternatively, the method may comprise setting up and connecting, by the tendons, the counterweight in its sinking state under the float, followed by towing the counterweight and the float to the offshore wind turbine installation site.

Still alternatively, the method may comprise connecting the tendons pre-installed on the float to the counterweight in its floating state, followed by setting up towing lines comprising tugs, the float and the counterweight in its floating state, followed by towing the assembly to the offshore wind turbine installation site.

Preferably, the lowering of the counterweight under the semi-submersible float is carried out gradually by using ballast chains and then by gradually deflating the airbags. In this case, the airbags can be withdrawn from the main structure after being deflated.

### BRIEF DESCRIPTION OF THE DRAWINGS

FIG. 1 is a perspective view of a counterweight according to one embodiment of the invention.

FIG. 2 is a side view of the counterweight of FIG. 1.

FIG. 3 is a perspective view of a counterweight according to another embodiment of the invention.

FIG. 4 is a side view of the counterweight of FIG. 3.

FIG. 5 is a view representing one example of towing of the counterweight according to the invention for installation.

FIG. 6 represents the next step of lowering the counterweight under the float for installation.

FIG. 7 represents the next step of withdrawing the airbags from the counterweight under the float for installation.

FIG. 8 is a view of an installed offshore wind turbine whose float is equipped with a counterweight according to the invention.

### DESCRIPTION OF THE EMBODIMENTS

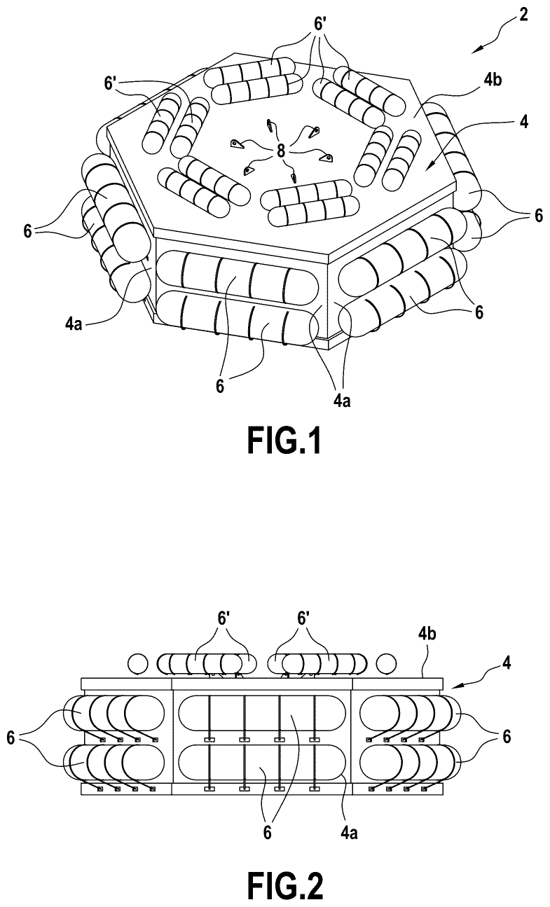

The invention relates to the general field of semi-submersible floats for offshore wind turbines. The stability of these floats is ensured by a counterweight 2 as the one represented in FIGS. 1 and 2.

According to the invention, the counterweight 2 can be configured to be sinking (hereinafter referred to as “sinking state”) or floating (hereinafter referred to as “floating state”). The counterweight 2 comprises a main counterweight structure 4 made of a material that makes it sink when immersed in water.

For example, this main counterweight structure 4 can be made of concrete, steel or composite materials.

A plurality of airbags 6 is removably fixed to the main counterweight structure 4 so as to make the counterweight floating when the airbags are inflated. An airbag is a cushion that is formed from a flexible membrane or shell (as opposed to a rigid element).

Moreover, as represented in FIGS. 1 and 2, this main counterweight structure 4 may have a geometric shape of a polyhedron (here a hexagon) with a plurality of lateral faces 4a on which the airbags 6 are removably fixed.

More specifically, two airbags 6 are fixed on each lateral face 4a of the main counterweight structure 4. In addition, a plurality of additional airbags 6′ is fixed on the upper face 4b of the main structure 4.

It will be noted that the upper face 4b of the main structure 4 also comprises a plurality of pad-eyes 8 to allow fixing ballast links (not represented) connecting the counterweight to the semi-submersible float.

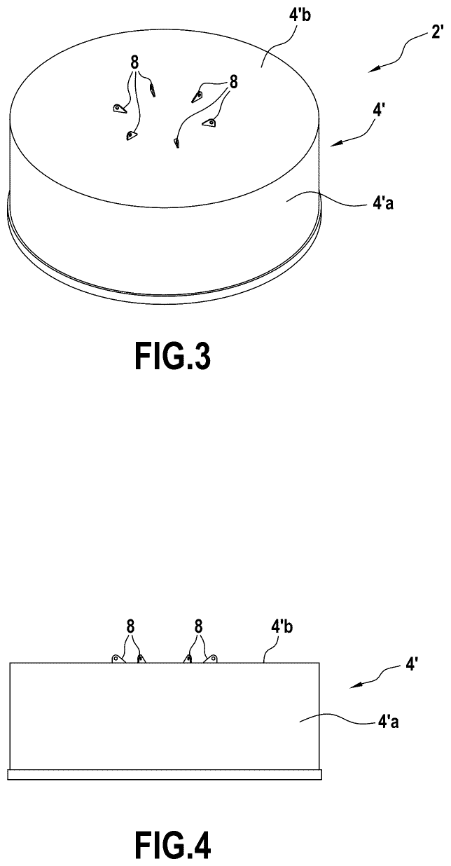

Alternatively, as represented in FIGS. 3 and 4, the main counterweight 2′ structure 4′ may have a geometric shape of a cylinder on the periphery 4′a of which the airbags are removably fixed (not represented in FIGS. 3 and 4).

As previously, the upper face 4′b of the main structure 4′ also comprises a plurality of pad-eyes 8 to allow fixing the ballast links.

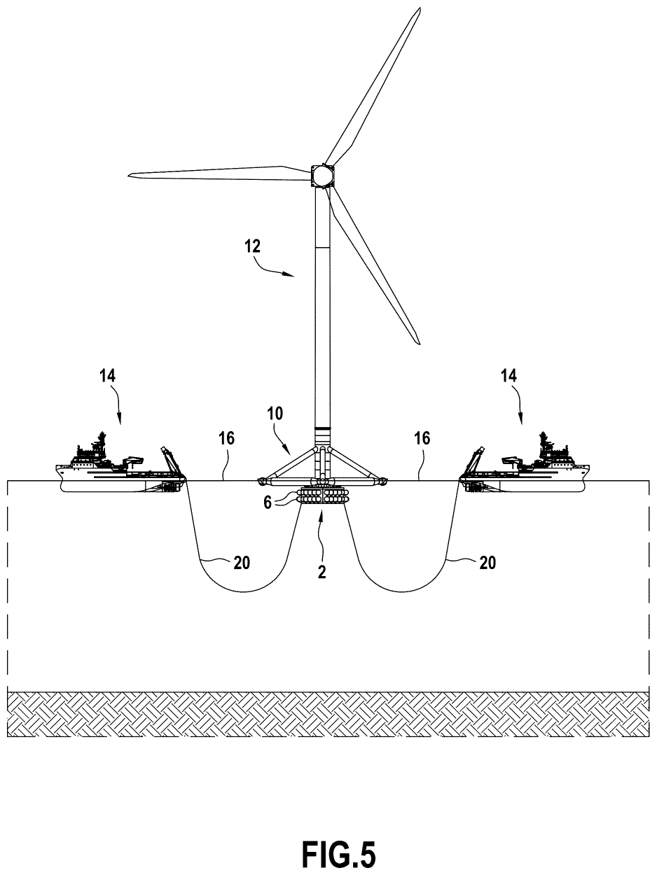

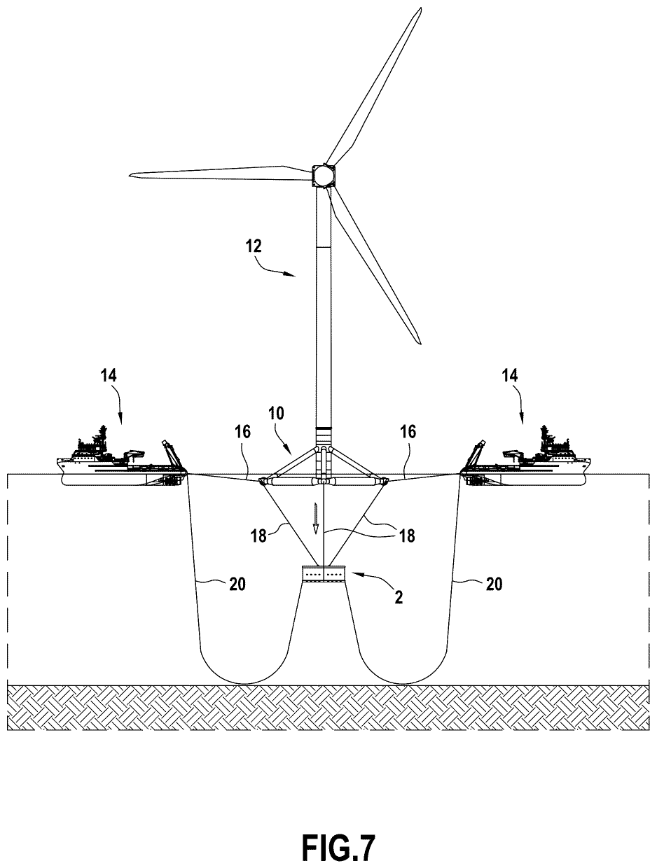

In relation to FIGS. 5 to 8, one example of a method for installing a counterweight according to the invention will now be described.

In this example of an installation method, the counterweight 2 is intended to ensure the stability of a float 10 of a wind turbine 12, this float being able to be ballastable or non-ballastable, for example by having a structure similar to the one described in the publication WO 2019/106283.

During an initial stage of the method which takes place at the dock, the deflated airbags 6 are fixed to the main structure of the counterweight 2. Then, the airbags are inflated to make the counterweight floating before it is launched into the water.

As represented in FIG. 5, the counterweight 2 in this floating state is connected under the float 10 by tendons (not represented in FIG. 5), launched into the water, and then towed to the offshore wind turbine installation site by two tugs 14 connected to the counterweight by ballast chains 20 and to the float by towing cables 16.

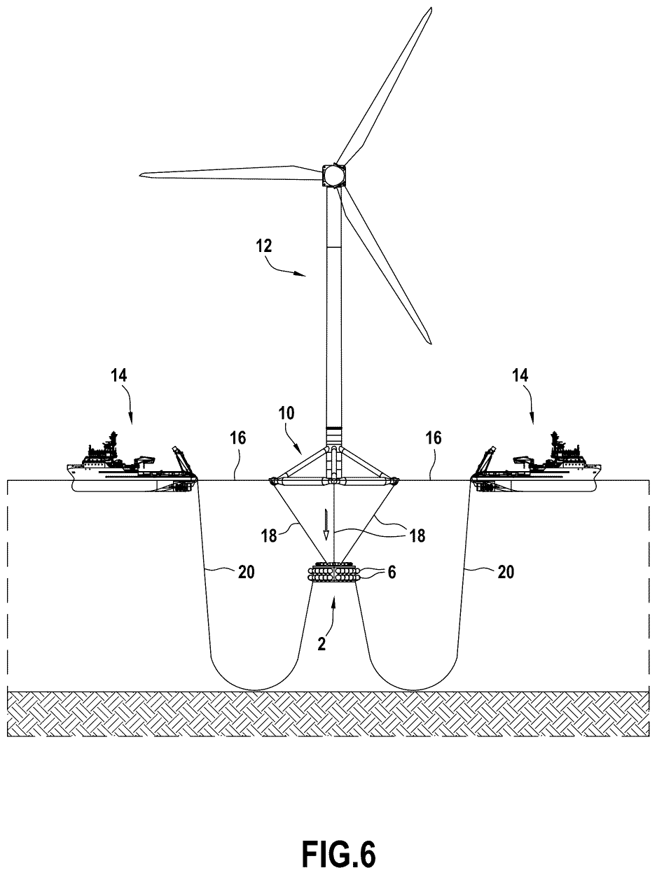

The counterweight 2 is then gradually lowered under the float 10 (FIG. 6), for example by using ballast chains 20 that are gradually removed from the tugs and/or by gradually deflating the airbags 6.

Once deflated, the airbags can be withdrawn from the counterweight 2 and the tendons 18 connecting the counterweight to the float 10 become tensioned and exert a downward force on the latter.

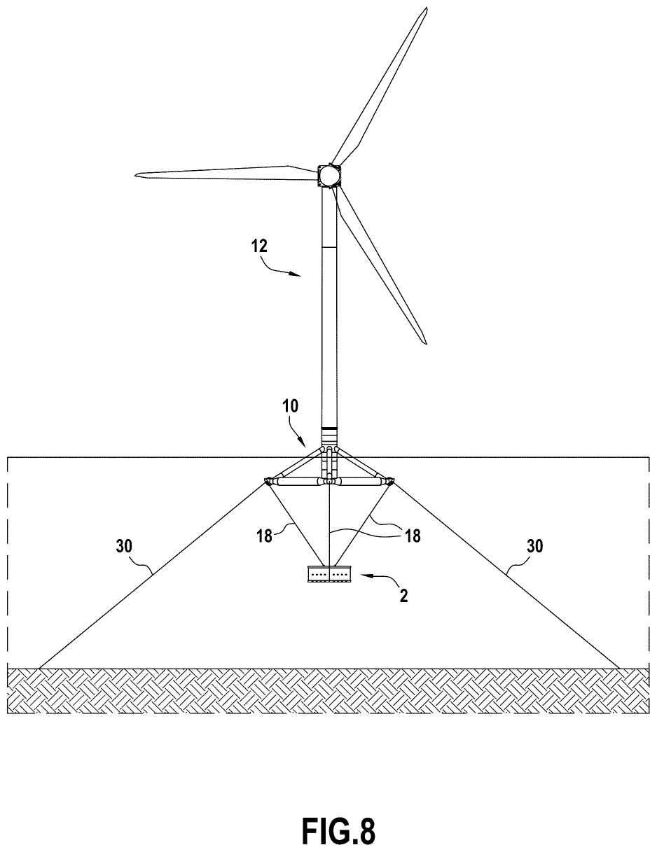

The anchor lines 30 are then connected to the float 10 to ensure that it is held position and the ballast chains can be disconnected from the tug (FIG. 8). Alternatively, the ballast chains can be permanent.

It should be noted that in this example of an installation method, it is provided to set up and connect, by the tendons, the counterweight in its sinking state under the float, and then to tow the counterweight and the float to the offshore wind turbine installation site.

Alternatively, the towing of the counterweight in its floating state can be carried out to the offshore wind turbine installation site separately from the towing of the semi-submersible float of the offshore wind turbine. In this case, this towing step is followed by the connection of the tendons pre-installed on the float to the counterweight.

Alternatively, it may be provided to connect the tendons pre-installed on the float to the counterweight in its floating state, and then to set up towing lines comprising tugs, the float and the counterweight in its floating state. The towing of the assembly to the offshore wind turbine installation site is then carried out.

1.-10. (canceled)

11. A counterweight for a semi-submersible float of an offshore wind turbine, which can be configured in a sinking state or a floating state, comprising a main counterweight structure made of a material that makes it sinking when immersed in water, and a plurality of airbags removably fixed to the main structure so as to make the counterweight floating when the airbags are inflated.

12. The counterweight according to claim 11, wherein the main structure is made of concrete, steel or composite materials.

13. The counterweight according to claim 11, wherein the main structure has a cylindrical or polyhedral shape with a plurality of lateral faces on which the airbags are removably fixed.

14. The counterweight according to claim 13, wherein the main structure has the shape of a hexagonal prism.

15. A method for installing a counterweight according to claim 11, comprising, in an indeterminate order:
securing at the dock the deflated airbags to the main structure;
inflating the airbags to make the counterweight floating prior to launching it into the water;
launching into the water the counterweight in its floating state;
towing the counterweight to the offshore wind turbine installation site;
connecting, via tendons, the counterweight under the semi-submersible float of the offshore wind turbine; and
lowering the counterweight under the semi-submersible float in order to tension the tendons and exert a downward force on the semi-submersible float.

16. The method according to claim 15, comprising towing the counterweight in its floating state to the offshore wind turbine installation site separately from towing the semi-submersible float of the offshore wind turbine, followed by connecting the tendons pre-installed on the float to the counterweight.

17. The method according to claim 15, comprising setting up and connecting, by the tendons, the counterweight in its sinking state under the float, followed by towing the counterweight and the float to the offshore wind turbine installation site.

18. The method according to claim 15, comprising connecting the tendons pre-installed on the float to the counterweight in its floating state, followed by setting up towing lines comprising tugs, the float and the counterweight in its floating state, followed by towing the assembly to the offshore wind turbine installation site.

19. The method according to claim 15, wherein the lowering of the counterweight under the semi-submersible float is carried out gradually by using ballast chains and then by gradually deflating the airbags.

20. The method according to claim 19, wherein the airbags are withdrawn from the main structure after being deflated.
